(19) United States
(12) Patent Application Publication
(10) Pub. No.: US 2024/0319536 A1
(43) Pub. Date: Sep. 26, 2024

(54) DISPLAY DEVICE HAVING MICRO-TYPE LIGHTING UNITS IN BACKLIGHT THEREOF

(71) Applicant: YingLight Technology Co. Ltd., Dacun Township (TW)

(72) Inventor: Ping-Yu TSAI, Dacun Township (TW)

(21) Appl. No.: 18/615,113

(22) Filed: Mar. 25, 2024

(30) Foreign Application Priority Data
Mar. 24, 2023 (TW) 112111273

(51) Int. Cl. G02F 1/13357; G02F 1/1335; G02F 1/1343

(52) U.S. Cl. CPC G02F 1/133603; G02F 1/133514; G02F 1/133528; G02F 1/134309

(57) ABSTRACT

The display device includes a backlight module, a light switching layer and a color filtering layer. The backlight module includes a plurality of micro light emitting units, wherein each of the micro light emitting units is independently controlled to emit a light. The light switching layer is located above the backlight module, wherein the light switching layer controls whether a light emitted from each of the micro light emitting unit of the backlight module penetrates the light switching layer or not. The color filtering layer is located above the light switching layer, wherein the color filtering layer includes a plurality of quantum dots with different colors, a color of the light emitted by each of the micro light emitting unit is converted by each of the quantum dots, and a plurality of sub-pixel units with different colors are formed by each of the quantum dots.

### RELATED APPLICATIONS

This application claims priority to Taiwan Application Serial Number 112111273, filed Mar. 24, 2023, which is herein incorporated by reference.

### BACKGROUND

### Technical Field

The present disclosure relates to a display device, more specifically, the present disclosure relates to a display device with micro light emitting units in backlight module thereof.

### Description of Related Art

Liquid crystal displays (LCDs) have recently acquired appeal as an important human-machine interface. LCD devices can be used to display complex texts on portable electronic devices, computers, and televisions.

Liquid crystal display (LCD) devices are increasingly popular and have become mainstream due to their large visible area, compact size, and low power consumption. A conventional LCD device 100 is shown in FIG. 1. The LCD device 100 includes a backlight module 111, a first polarizer 112, a first substrate 113, a transistor layer 114, a first electrode 115, a liquid crystal layer 116, a second electrode 117, a color filter 118, a second substrate 119, and a second polarizer 120 arranged from bottom to top. A brief description of the operation mechanism of the LCD device 100 is described. Liquid crystal molecules in the liquid crystal layer 116 are twisted when an electric field is applied. One or more transistors in the transistor layer 114 are used to control the twisting direction of the liquid crystal molecules and acted as a light switch. Light emitted from the backlight module 111 passes through the first polarizer 112 and the second polarizer 120 to produce light of different polarization directions that combine with the twist direction of the liquid crystal molecules to regulate the brightness change, resulting in a grey scale. A plurality of sub-pixels 118a having different colors are formed through the color filter 118. By combining a plurality of sub-pixels 118a, a full color pixel can be formed, thereby forming a full color visible to the human eye. The formation of the sub-pixels 118a is defined by each transistor in the transistor layer 114. In addition, an orientation film (not shown) may be disposed on the first substrate 113 and the second substrate 119 for regulating the orientation directions of the liquid crystal molecules. An electric field can be applied to the transistor layer 114 through the first electrode 115 and the second electrode 117.

However, the power efficiency, brightness, contrast and color uniformity of this LCD device 100 are low because only a small amount of light emitted from the backlight module 111 can pass through the liquid crystal layer 116, and the manufacturing process of the transistor layer 114 is complex, thereby increasing the manufacturing cost. In addition, the structure of the conventional color filter 118 uses color photoresists to form the sub-pixels 118a, and the colors produced no longer fulfill modern criteria for high resolution, high brightness, high contrast and wide color gamut. Improvements to the LCD device 100 described above are therefore still required.

### SUMMARY

According to one aspect of the present disclosure, a display device is provided. The display device includes a backlight module, a light switching layer and a color filtering layer. The backlight module includes a plurality of micro light emitting units, wherein each of the micro light emitting units is independently controlled to emit a light. The light switching layer is located above the backlight module, wherein the light switching layer controls whether a light emitted from each of the micro light emitting unit of the backlight module penetrates the light switching layer or not. The color filtering layer is located above the light switching layer, wherein the color filtering layer includes a plurality of quantum dots with different colors, a color of the light emitted by each of the micro light emitting unit is converted by each of the quantum dots, and a plurality of sub-pixel units with different colors are formed by each of the quantum dots.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram showing the structure of a conventional LCD device;

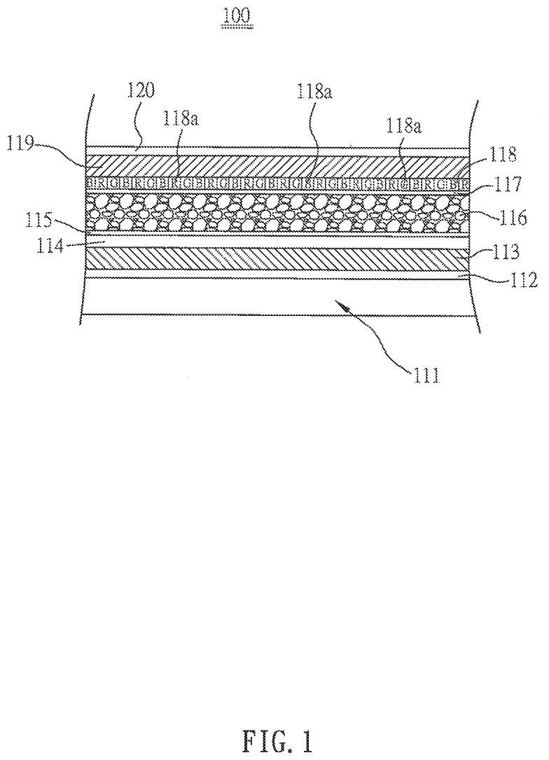

FIG. 2A is a schematic diagram showing the structure of a display device according to one embodiment of the present disclosure;

FIG. 2B is a schematic diagram showing the structure of a display device according to another embodiment of the present disclosure;

FIG. 3A is a schematic diagram showing a complete structure of the light switching layer of FIG. 2A when a liquid crystal material is used;

FIG. 3B is a schematic diagram showing a complete structure of the light switching layer of FIG. 2B when the liquid crystal material is used;

FIG. 4A is a schematic diagram showing a complete structure of the light witching layer of FIG. 2A when an electrochromic material is used; and

FIG. 4B is a schematic diagram showing a complete structure of the light switching layer of FIG. 2B when the electrochromic material is used.

### DETAILED DESCRIPTION

Several embodiments of the present disclosure are described below with reference to the drawings. For the sake of clarity, many practical details will be described in the following description. However, it should be appreciated that these practical details should not be used to limit the present disclosure. That is, in some embodiments of the invention, these practical details are not necessary. In addition, in order to simplify the drawings and to concentrate on the main technical features of the present disclosure, some of the known and non-essential structures and components are shown in the drawings in a simple schematic manner or are omitted. In addition, similar components may be identified by the same number.

In the present disclosure, the terms “first”, “second”, “top”, “bottom” and “between” are used to describe a relative position, but in practice changes in the order of arrangement are not excluded depending on the actual situation. For example, if the substrate is on the top layer, the other layers may be arranged in a downward direction and the relative positions of “first”, “second”, “top” and “bottom” may change accordingly.

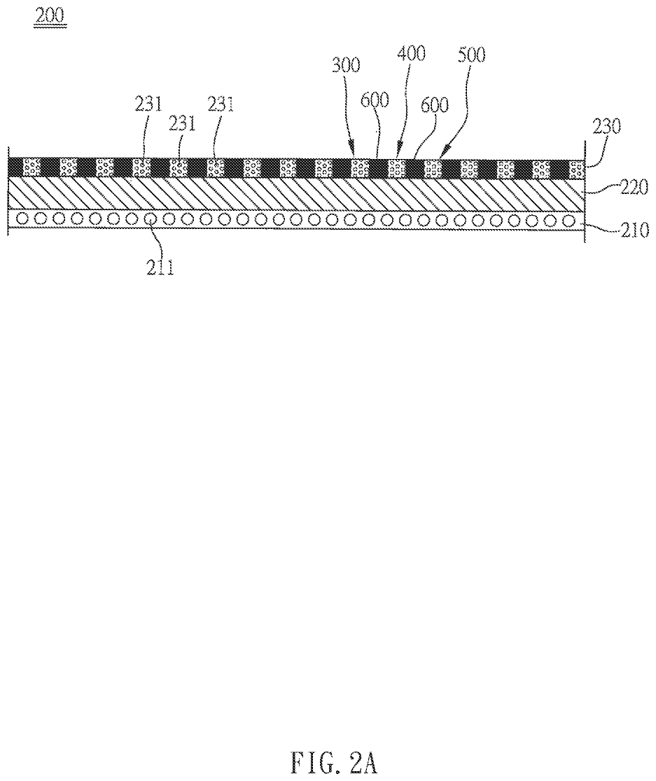

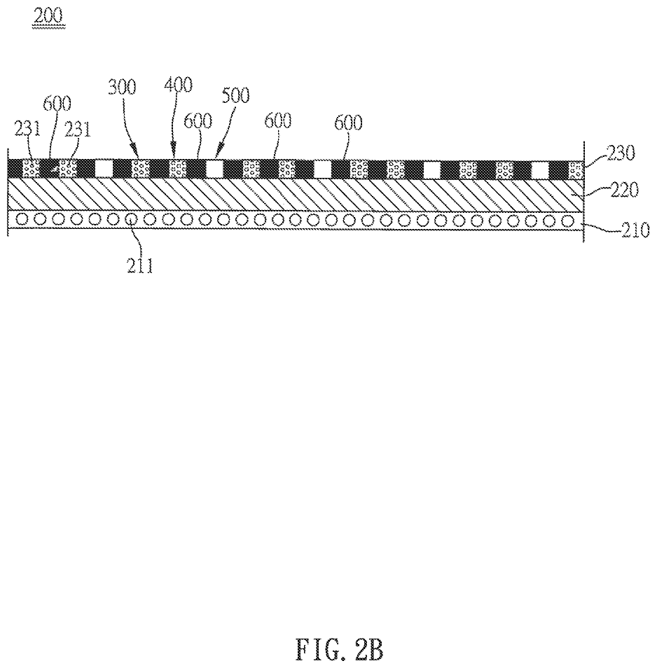

Please refer to FIGS. 2A and 2B.

A display device 200 includes a backlight module 210, a light switching layer 220 located above the backlight module 210 and a light filtering layer 230 located above the light switching layer 220. The backlight module 210 including a plurality of micro light emitting units 211.

Each of the micro light emitting units 211 in the backlight module 210 can be independently controlled to emit a light.

The light switching layer 220 controls whether the light emitted by the micro light emitting units 211 of the backlight module 210 penetrate the light switching layer 220 or not. More specifically, when the light emitted by the micro light emitting units 211 of the backlight module 210 penetrate the light switching layer 220, the light switching layer 220 is controlled to is regulated to vary its transmittance in order to adjust the light penetration ratio. The brightness (grey scale), contrast, and other visual properties can all be changed by varying the light penetration ratio.

The light filtering layer 230 includes a plurality of quantum dots 231 with different colors, and the color of the light emitted by each micro light emitting unit 211 is converted by each quantum dot 231, and a plurality of sub-pixel units 300, 400, 500 with different colors are constructed in the light filtering layer 230 by means of the quantum dots 231 with different colors.

Quantum dots 231 are small semiconductor crystals with dimensions down to the nanometer scale. Their properties are very different from those of bulk semiconductors. The most notable feature of quantum dots 231 is the modulation of the semiconductor bandgap by changing their size and discrete energy levels (the so-called Quantum Confinement Effect). In addition, when applying quantum dots 231 to displays, a narrower spectrum can be obtained due to their narrower emission line widths (e.g., emission half width (FWHM) of about 20 to 30 nanometers). Very high color saturation can be obtained through the narrow spectrum, which can cover more than 90% of the most stringent Rec. 2020 color gamut standard, so that a wide color gamut visual effect can be obtained. The narrow emission linewidth of the quantum dots 231 also makes them suitable for use as LED backlighting elements in high-definition displays, such as 8K or higher resolution displays.

The material of the quantum dot 231 may include an II-VI group element compound, a III-V group element compound, a calcium titanite (Perovskite) quantum dot, a core-shell structural compound formed by capping of the above mentioned II-VI group element compounds and/or III-V group element compounds, or doped nanocrystalline particles. The II-VI group element compounds may include cadmium selenide (CdSe), cadmium telluride (CdTe), magnesium sulfide (MgS), magnesium selenide (MgSe), magnesium telluride (MgTe), calcium sulfde (CaS), calcium selenide (CaSe), calcium telluride (CaTe), strontium sulfide (SrS), strontium selenide (SrSe), strontium telluride (SrTe), barium sulfide (BaS), barium telluride (BaTe), zinc sulfide (ZnS), zinc selenide (ZnSe), zinc telluride (ZNTe) or cadmium sulfide (CdS), etc. The III-V group element compounds may include gallium nitride (GaN), gallium phosphide (GaP), gallium arsenide (GaAs), indium nitrite (InN), Indium phosphide (InP), indium arsenide (InAs), etc. However, the materials are not limited to the above.

The quantum dots 231 may be red quantum dots, green quantum dots, blue quantum dots or any combination of the foregoing colors. The light emitted by the micro light emitting units 211 can excite the quantum dots 231, and can be converted by the quantum dots 231 into different light colors, which are eventually presented to the human eye to form a color image. It is known that a color image is composed of multiple pixel units, and each of the pixel units is composed of multiple sub-pixel units. Accordingly, the quantum dots 231 of different colors may be stacked of each other to form multiple sub-pixel units 300, 400, 500 of different colors. The quantum dots 231 of different colors may be arranged in different ways to form different color saturations. For example, the quantum dots 231 may be arranged in square, triangular, or mosaic shapes to form different arrangements of the sub-pixel units 300, 400, 500 to achieve different color rendering effects.

The quantum dots 231 may be in the form of particles, the diameter of which may be between 1 nm and 10 nm, and the weight ratio of the quantum dots 231 may be adjusted differently.

The formation of the stacking arrangement of each of the quantum dots 231 can be achieved by such means as the ink-jet method, the chemical colloidal method, the self-assembly method, the photo-lithography and etching method, or the split-gate method. Multilayered quantum dots 231 can be synthesized by the chemical colloidal method, which is easily processed and suitable for mass production. Self-assembly method can adopt chemical vapor deposition process to make quantum dots 231 self-polymerized on the surface of a specific substrate, which can produce regular arrangement of quantum dots 231 in large quantities. Photo-lithography and etching method uses a light or an electron beam to form the desired pattern directly onto the substrate. The split-gate method uses an applied voltage to create a two-dimensional confinement in the plane of a two-dimensional quantum well, which can change the shape and size of the quantum dots 231.

In various embodiments, the micro light emitting unit 211 may emit different light colors to form a backlight of different colors, and be converted into different light colors by different colored quantum dots 231.

In the embodiment of FIG. 2A, the color of the light emitted by the micro light emitting unit 211 includes red, green, and blue, and at this time, the quantum dots 231 includes red quantum dots, green quantum dots, and blue quantum dots, and the color of each of the quantum dots 231 corresponds to the color of the light emitted by each of the micro light emitting units 211. In other words, the red light emitted by the micro light emitting unit 211 is converted into red light by the red quantum dots, the green light emitted by the micro light emitting unit 211 is converted into green light by the green quantum dots, and the blue light emitted by the micro light emitting unit 211 is converted into blue light by the blue quantum dots, and then the red light converted by the red quantum dots is used to form the red sub-pixel unit 300, the green light converted by the green quantum dots is used to form the green sub-pixel unit 400, and the blue light converted by the blue quantum dots is used to form the blue sub-pixel unit 400. By combining the red sub-pixel unit 300, the green sub-pixel unit 400 and the blue sub-pixel unit 500, a full light color can be achieved.

In the embodiment of FIG. 2B, each of the micro light emitting unit 211 only emits a blue color light, and the quantum dots 231 in the light filtering layer 230 only include red quantum dots and green quantum dots, there is no blue quantum dot 231 in the filter layer 230. In other words, some of the blue color light emitted by the micro light emitting unit 211 is converted to red light to form the red sub-pixel unit 300 by the red quantum dot, some of the blue color light emitted by the micro light emitting unit 211 is converted to green light to form the green sub-pixel unit 400 by the green quantum dot, and some of the blue color light emitted by the micro light emitting unit 211 is directly emitted without being converted by any of the quantum dot. Therefore, a full color light can be achieved. In the embodiment, the light emitted by the micro light emitting unit 211 can also be a violet color light.

In the above-described display device 200, a mask 600 may be disposed between the sub-pixel units 300, 400, 500 formed by the quantum dots 231, which may block the stray light between the sub-pixel units 300, 400, 500, avoiding the mixing of light, and ensuring the uniformity and saturation of the light emitted. Mask 600 is usually made of black light-absorbing material, but this is not a limitation.

The light switching layer 220 controls the penetration ratio of the light emitted from the micro light emitting unit 211 of the backlight module 210 to control the brightness (grey scale), contrast and other optical characteristics. The light switching layer 220 can be made of liquid crystal materials or electrochromic materials.

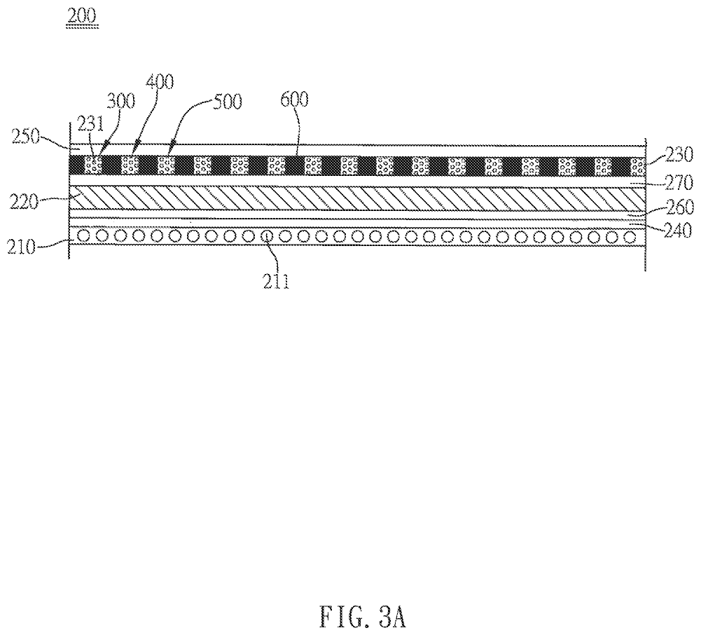

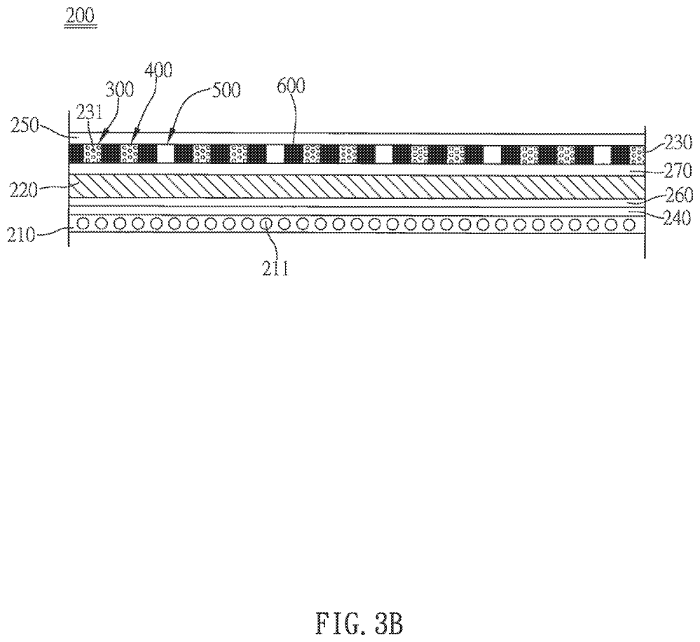

FIGS. 3A and 3B show the complete structure of the display device 200 when the light switching layer 220 is made of a liquid crystal material. Compared to the embodiments in FIGS. 2A and 2B, in FIGS. 3A and 3B, the display device 200 includes a first polarizer 240 located between the backlight module 210 and the light switching layer 220, a second polarizer 250 located above the light filtering layer 230, a first electrode 260 located between the backlight module 210 and the light switching layer 220, and a second electrode 270 located between the light switching layer 220 and the light filtering layer 230. The transmittance of the light switching layer 220 is controlled by the electric field formed between the first electrode 260 and the second electrode 270 to form a desired grey scale.

In the display device 200, the dimension of each micro light emitting unit 211 may be millimeters or less, preferably micrometers. The micro light emitting units 211 usually use inorganic light emitting diodes (LEDs), which are discontinuous point light sources, resulting in a lack of backlight uniformity. In addition, due to the inherent light emitting characteristics of point light sources, visual defects such as light leakage, low contrast ratio, and poor color saturation are generally formed. In order to solve the above problems, one way is to reduce the size of each micro light emitting unit 211 so that more micro light emitting units 211 can be placed under the same area, in order to form a light emitting effect similar to that of a surface light source. The present disclosure also introduces quantum dots 231 of different colors into the light filtering layer 230 to combine with the micro light emitting units 211 whose dimensions have been reduced to micrometer range, which at the same time can improve the color saturation and increase the color gamut in order to meet the needs of future high-definition display devices.

In FIG. 3A, the color of the light emitted from the micro light emitting unit 211 includes red, green and blue, and at the time, the quantum dots 231 includes red quantum dots, green quantum dots and blue quantum dots. The red light emitted from the micro light emitting unit 211 is converted through the red quantum dots into a red color light to form the red sub-pixel unit 300, the green light emitted from the micro light emitting unit 211 is converted through the green quantum dots into a green color light to form the green sub-pixel unit 400, and the blue light emitted from the micro light emitting unit 211 is converted through the blue quantum dots into a blue color light to form the blue sub-pixel unit 500, and the masks 600 are disposed between each of the sub-pixel units 300, 400, and 500 to block the stray light. In FIG. 3B, there are no blue quantum dots in the color filtering layer 230. Each of the micro light emitting units 211 emit a blue color light, and some of the blue color lights emitted by the micro light emitting units 211 are converted by the red quantum dots into red color lights to form the red sub-pixel units 300, some of the blue color lights emitted by the micro light emitting units 211 are converted by the green quantum dots into green color lights to form the green sub-pixel units 400, and some of the blue color light some of the blue color lights emitted by the micro light emitting units 211 are emitted directly to form the blue sub-pixel units 500 without any quantum dot conversion.

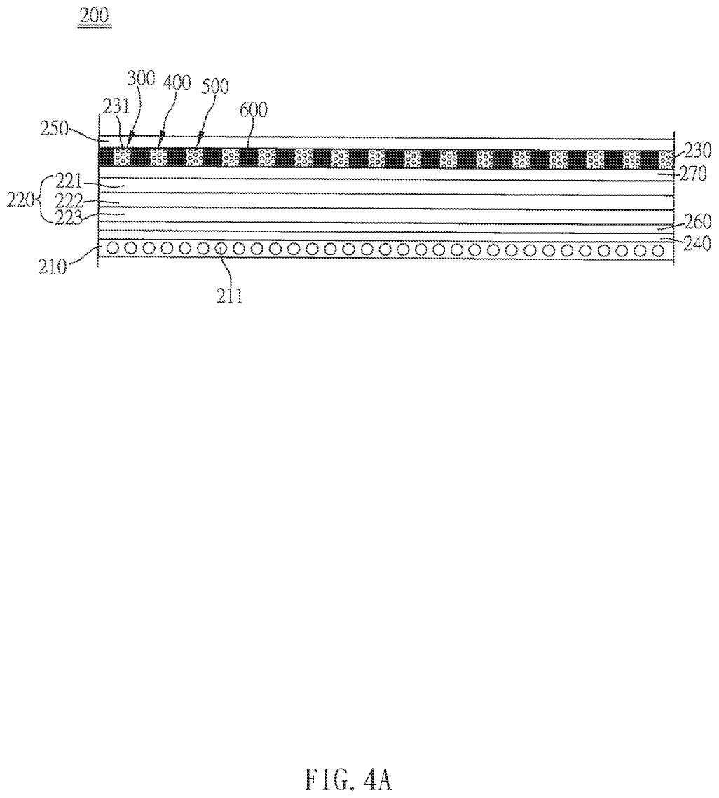

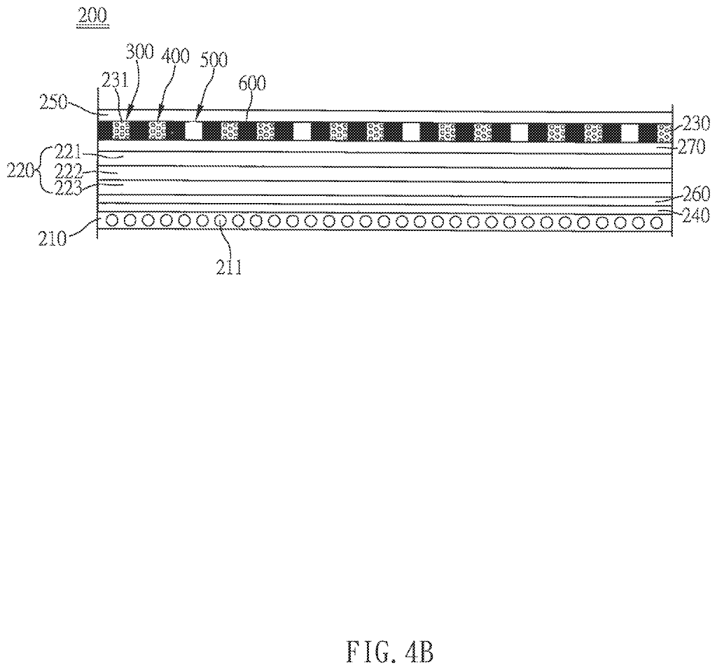

FIGS. 4A and 4B show examples of the complete structures of the display device 200 when the light switching layer 220 is made of an electrochromic material. Compared to the embodiments of FIGS. 2A and 2B, in FIGS. 4A and 4B, the display device 200 includes a first polarizer 240 located between the backlight module 210 and the light switching layer 220, a second polarizer 250 located above the light filtering layer 230, a first electrode 260 located between the backlight module 210 and the light switching layer 220, and a second electrode 270 located between the light switching layer 220 and the light filtering layer 230. The transmittance of the light switching layer 220 is controlled by the electric field formed between the first electrode 260 and the second electrode 270 to form a desired grey scale. In addition, based on the principle of electrochromism, the light switching layer 220 in FIGS. 4A and 4B is composed of an electrochromic material 221, an electrolyte layer 222, and an ion storage layer 223 arranged from top to bottom.

When a voltage is applied to the first electrode 260 and the second electrode 270, an electric field is formed therebetween, and an oxidation-reduction reaction occurs under the action of the electric field to cause the electrochromic material 221 to change color and form a transparent state, which allows the light emitted from the micro light emitting unit 211 to penetrate. In more detail, the electrons provided by the electrode layer and the ions inside the ion storage layer 223 and the electrolyte layer 222 undergo a redox reaction to cause a change in the structure of the electrochromic material 221 to change color, and the degree of color changing can be controlled by the electric field formed between the first electrode 260 and the second electrode 270, in order to control the desired grey levels.

In FIG. 4A, the color of the light emitted from the micro light emitting unit 211 includes red, green and blue, and at the time, the quantum dots 231 includes red quantum dots, green quantum dots and blue quantum dots. The red light emitted from the micro light emitting unit 211 is converted through the red quantum dots into a red color light to form the red sub-pixel unit 300, the green light emitted from the micro light emitting unit 211 is converted through the green quantum dots into a green color light to form the green sub-pixel unit 400, and the blue light emitted from the micro light emitting unit 211 is converted through the blue quantum dots into a blue color light to form the blue sub-pixel unit 500, and the masks 600 are disposed between each of the sub-pixel units 300, 400, and 500 to block the stray light. In FIG. 4B, there are no blue quantum dots in the color filtering layer 230. Each of the micro light emitting units 211 emit a blue color light, and some of the blue color lights emitted by the micro light emitting units 211 are converted by the red quantum dots into red color lights to form the red sub-pixel units 300, some of the blue color lights emitted by the micro light emitting units 211 are converted by the green quantum dots into green color lights to form the green sub-pixel units 400, and some of the blue color light some of the blue color lights emitted by the micro light emitting units 211 are emitted directly to form the blue sub-pixel units 500 without any quantum dot conversion.

In summary, the light emitted by the micro light emitting unit 211 of the backlight module 210 can excite quantum dots 231 with various colors and the color of the light can be converted by the quantum dots to form sub-pixel units 300, 400, 500 with red, green, blue or any combination of the foregoing colors, thereby forming a full-color image. Furthermore, through the characteristics of the quantum dots 231 that having narrow emission linewidth, uniform light emission and wide color gamut can be achieved. Furthermore, in one example, the wavelength of the light emitted by the micro light emitting unit 211 can be varied with the voltage applied between the first electrode 260 and the second electrode 270, which in turn can adjust the excitation efficiency of the quantum dots 231 with different colors. This is because different colored quantum dots 231 have different responses to the wavelength of the excitation light source, and changes in the applied voltage will cause the wavelength of the light emitted by the micro light emitting unit 211 to blue shift (peak wavelength shifted to a shorter wavelength) or red shift (peak wavelength shifted to a longer wavelength), and therefore the excitation efficiency of the different colored quantum dots 231 will also change accordingly.

Accordingly, the display device 200 in the present disclosure achieves higher light conversion efficiency, higher brightness, higher contrast, higher color saturation, wider viewing angle, and wider color gamut by combining the material properties of the quantum dots 231 with the micro light emitting unit 211 of reduced dimension. Furthermore, applying electrochromic material for the light switching layer 220 provides an alternative to the conventional liquid crystal material, providing an innovative structure that reduces manufacturing costs and achieves different efficacies.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display device comprising:
a backlight module comprising a plurality of micro light emitting units, wherein each of the micro light emitting units is independently controlled to emit a light;
a light switching layer located above the backlight module, wherein the light switching layer controls whether a light emitted from each of the micro light emitting unit of the backlight module penetrates the light switching layer or not; and
a color filtering layer located above the light switching layer, wherein the color filtering layer comprises a plurality of quantum dots with different colors, a color of the light emitted by each of the micro light emitting unit is converted by each of the quantum dots, and a plurality of sub-pixel units with different colors are formed by each of the quantum dots.

2. The display device of claim 1, wherein the color of the light emitted by each of the micro light emitting unit comprises red, green and blue, the quantum dots comprise red quantum dots, green quantum dots and blue quantum dots, and each of the quantum dots converts the color of the light emitted by each of the micro light emitting unit into a corresponding color.

3. The display device of claim 1, wherein each of the micro light emitting units emits a blue color light, and the quantum dots comprises red quantum dots and green quantum dots.

4. The display device of claim 1, wherein the light switching layer comprises a liquid crystal material.

5. The display device of claim 1, wherein the light switching layer comprises an electrochromic material.

6. The display device of claim 1, wherein when a light emitted by the backlight module penetrates the light switching layer, the light switching layer is controlled to change a transmittance in order to adjust a light penetration ratio of the light emitted by the backlight module.

7. The display device of claim 1, further comprising:
a first polarizer located between the backlight module and the light switching layer; and
a second polarizer located above the light filtering layer.

8. The display device of claim 1, further comprising:
a first electrode located between the backlight module and the light switching layer; and
a second electrode located between the light switching layer and the light filtering layer;
wherein a transmittance of the light switching layer is controlled by an electric field formed between the first electrode and the second electrode.

9. The display device of claim 1, wherein a wavelength of the light emitted by each of the micro light emitting units is varied with a voltage applied between the first electrode and the second electrode, thereby modulating a conversion efficiency of the quantum dots.

10. The display device of claim 1, wherein a mask is disposed between each of the quantum dots in the light filtering layer.

11. The display device of claim 1, wherein a dimension of each of the micro light emitting units is in a micrometer range.
